(19) United States
(12) Patent Application Publication
(10) Pub. No.: US 2011/0254252 A1
(43) Pub. Date: Oct. 20, 2011

(54) FOLDING BICYCLE WITH TELESCOPIC ROD

(75) Inventors: LONG-CHANG HSIEH, Changhua City (TW); Tzu-Hsia Chen, Huwei Township (TW); Chien-Lin Chen, Huwei Township (TW)

(73) Assignee: National Formosa University, Huwei Township (TW)

(21) Appl. No.: 12/851,481

(22) Filed: Aug. 5, 2010

(30) Foreign Application Priority Data
Apr. 20, 2010 (TW) 099112294

(51) Int. Cl. B62K 15/00

(52) U.S. Cl. 280/639

(57) ABSTRACT

A folding bicycle with a telescopic rod includes a bicycle body, a folding switch and the telescopic rod. The bicycle body includes front and rear frames that are foldable against each other. The telescopic rod has two ends respectively and pivotally connected to the front and rear frames, and has an engaging position thereof. The folding switch is disposed on a lateral side of the bicycle body to fix the front and rear frames together or release from each other. When the bicycle body is unfolded, the telescopic rod is driven to extend, and the folding switch fixes the front and rear frames together. When the bicycle body is folded in half, the telescopic rod is driven to retract and fixed in the engaging position. Thus, the present invention has advantages of enhanced rigidity of the bicycle body, easily movability, auxiliary positioning, simply rapid folding and lower costs.

### BACKGROUND OF THE INVENTION

1. Technical Field

The present invention relates to a folding bicycle with a telescopic rod. More particularly, the present invention relates to a folding bicycle equipped with a telescopic rod to be folded rapidly, and featuring advantages including enhanced rigidity of the bicycle body, easy movability in the folded state of the folding bicycle, auxiliary positioning, easily rapid folding, and lower costs.

2. Description of Related Art

Recently, as a result of urbanization, urban population density has increased to such extent that living space for people is increasingly reduced. Therefore, folding bicycles, which have many advantages such as high compactness, lightweight, and high adjustability, have also become a hot seller on the market gradually and very popular among consumers.

Generally speaking, folding bicycles are an advantageous transportation tool for either commuting or shopping. Besides lately, due to the rising awareness of environmental protection, exhaust-free bicycles even become keys to governmental promotions. In countries like the Netherlands and Germany, for example, in order to encourage people to commute and travel by bicycle, not only exclusive bicycle lanes are increasingly built in urban areas, but also bicycle safekeeping stations are established near mass transportation stations. Compact and conveniently portable folding bicycles are the most comparable products to the above cyclist-friendly promotions and facilities.

Technical scopes involved by commercially available longitudinally folding bicycles are more complicated. Such bicycles are usually folded by folding one of the front wheel and the rear wheel thereof downwards. The folding way of such bicycles is more originally creative, and represents manufacturer's frame better. Hence, such bicycles come at a higher price all the time, and as the folding way employed by such bicycles is unique, users must be very familiar with folding steps thereof in order to fold the bicycles rapidly. Conclusively, such folding bicycles are disadvantaged by high prices and complicated folding ways.

In addition, after conventional folding bicycles are folded, these bicycles need to be carried by users in order to be moved around. Therefore, it takes a lot of labors to move these conventional folding bicycles.

Hence, it is necessary to overcome the aforesaid drawbacks and problem of the prior art by developing new products.

### SUMMARY OF THE INVENTION

It is an object of the present invention to provide a folding bicycle having a telescopic rod, wherein the folding bicycle has advantages including increased rigidity of bicycle bodies, easy movability, auxiliary positioning, conveniently rapid folding, and lower costs, and hence, the present invention solves the aforementioned problems of the conventional folding bicycles, namely including complexity of folding ways, high selling prices, and need of laborious carry to move bicycles.

The technical resolutions adopted by the present invention to solve the aforementioned problem and achieve foregoing objects is to provide a folding bicycle having a telescopic rod, wherein the folding bicycle comprises:

a bicycle body comprising a front frame, a rear frame, and a pivot joint, wherein the front frame comprises a front pivot portion, the rear frame comprises a rear pivot portion, and the front frame and the rear frame are coupled by the pivot joint and are respectively rotatable about a rotation axis defined by the pivot joint so as to be folded in half;

a telescopic rod having two ends which are respectively and pivotally connected with the front pivot portion and the rear pivot portion; and

a folding switch being configured to fix/release the front frame and the rear frame to/from each other.

Whereby, when the bicycle body is unfolded, the telescopic rod is in an extended state thereof, and the folding switch fixes the front frame and the rear frame to each other. On the other hand, when the bicycle body is folded in half, the telescopic rod is in a retracted state thereof, and the folding switch releases the front frame and the rear frame from each other.

### BRIEF DESCRIPTION OF THE DRAWINGS

The invention as well as a preferred mode of use, further objects, and advantages thereof will be best understood by referring to the following detailed description of an illustrative embodiment in conjunction with the accompanying drawings, in which:

FIG. 1 is an exploded perspective view of a folding bicycle with a telescopic rod according to the present invention;

FIG. 2 is an assembled perspective view of the folding bicycle in FIG. 1;

FIG. 3 is another assembled perspective view of the folding bicycle in FIG. 1 with partially enlarged;

FIG. 4 is a perspective view of the telescopic rod according to the present invention;

FIG. 5 is a side view of a folding switch according to the present invention;

FIG. 6 is a partial top view of a bicycle body according to the present invention, wherein the bicycle body is in an unfolded state thereof;

FIG. 7 is a top view showing the bicycle body of the folding bicycle starts to be folded according to the present invention;

FIG. 8 is a perspective view of the bicycle body of the folding bicycle according to the present invention, wherein the bicycle body is in a folded state thereof;

FIG. 9 is a top view of the bicycle body of the folding bicycle according to the present invention with partially enlarged, wherein the bicycle body is in the folded state thereof; and

FIG. 10 is a perspective view showing another aspect of the present invention in a folded state thereof.

### DETAILED DESCRIPTION OF THE INVENTION

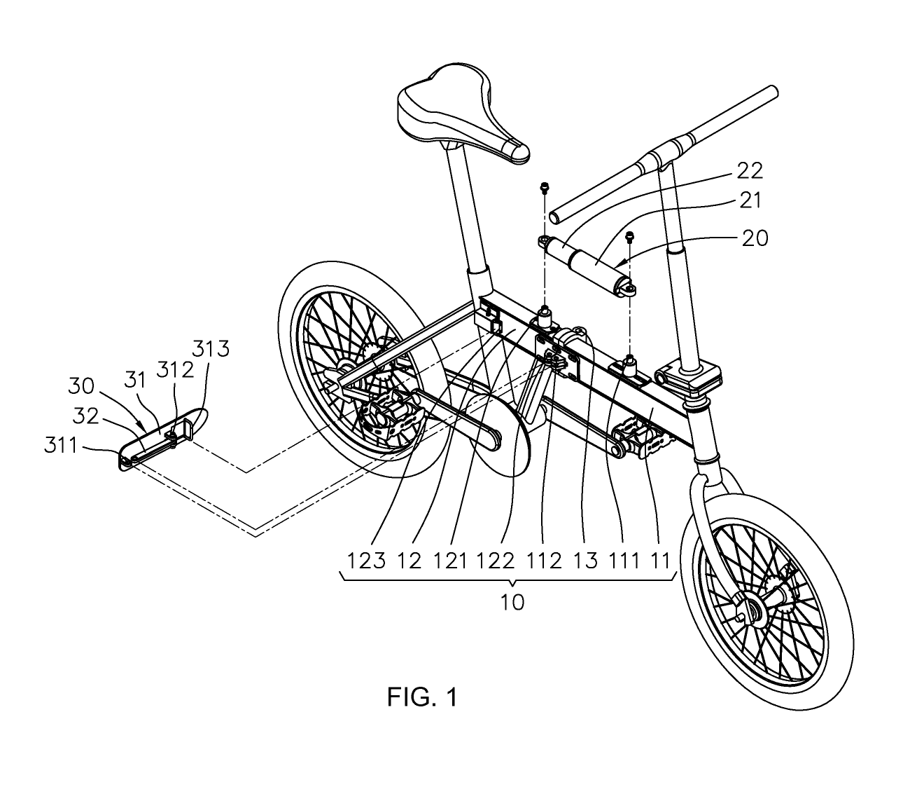

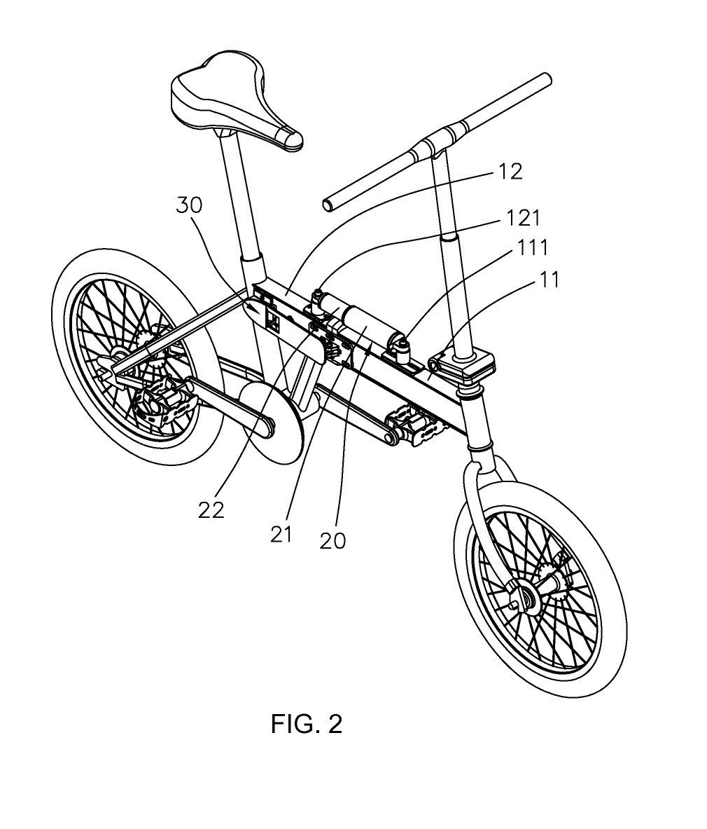

Referring to FIGS. 1, 2, and 3 for a first embodiment of a folding bicycle with a telescopic rod according to the present invention. The folding bicycle with a telescopic rod comprises a bicycle body 10, a telescopic rod 20, and a folding switch 30.

The bicycle body 10 comprises a front frame 11, a rear frame 12, and a pivot joint 13. The front frame 11 comprises a front pivot portion 111. The rear frame 12 comprises a rear pivot portion 121. The front frame 11 and the rear frame 12 are connected by the pivot joint 13, and can be rotated respectively about a rotation axis defined by the pivot joint 13 so as to be folded in half. The front frame 11 defines a lateral side equipped with a front pivot seat 112, and the rear frame 12 defines a lateral side equipped with a rear pivot seat 122 and a fixing portion 123.

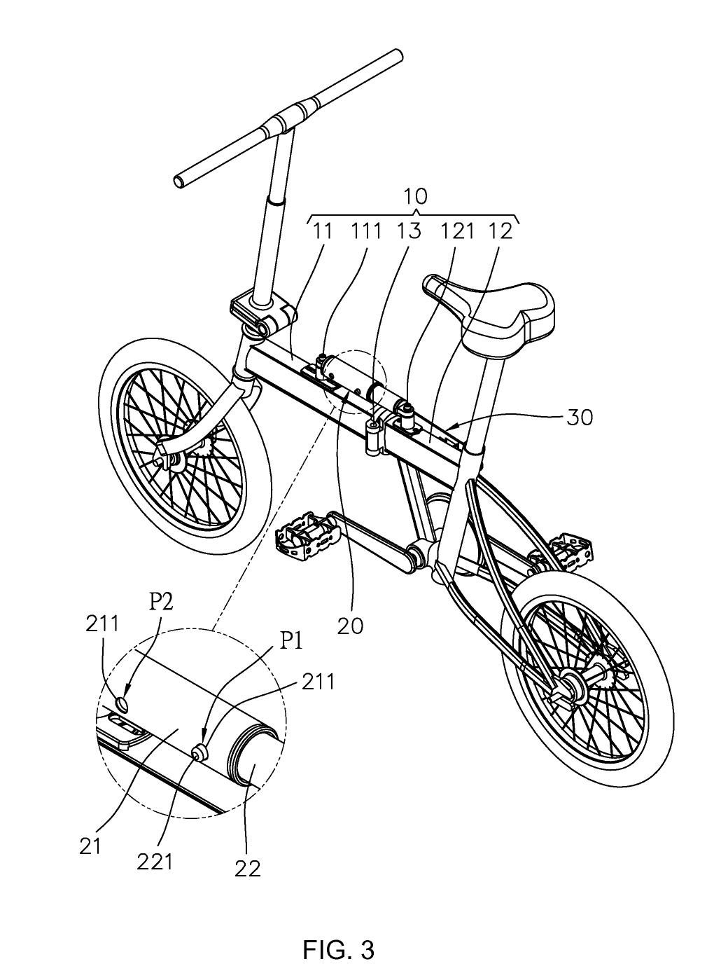

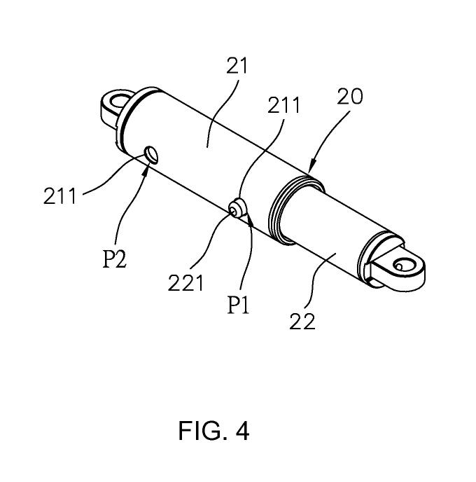

The telescopic rod 20 has two ends which are respectively and pivotally connected to the front pivot portion 111 and the rear pivot portion 121. As shown in FIGS. 3 and 4, the telescopic rod 20 includes an outer rod member 21 and an inner rod member 22. The outer rod member 21 is equipped with at least one positioning portion 211 while the inner rod member 22 comprises an engaging portion 221. The engaging portion 221 is configured to engage with the at least one positioning portion 211 so as to effectuate auxiliary positioning. In this embodiment of the present invention, the outer rod member 21 is provided with two positioning portions 211 located at a first position P1 and a second position P2, respectively. Besides, depending on whether the bicycle body 10 is unfolded or folded, the engaging portion 221 is engaged with the positioning portion 211 at a differently corresponding position to effectuate auxiliary positioning.

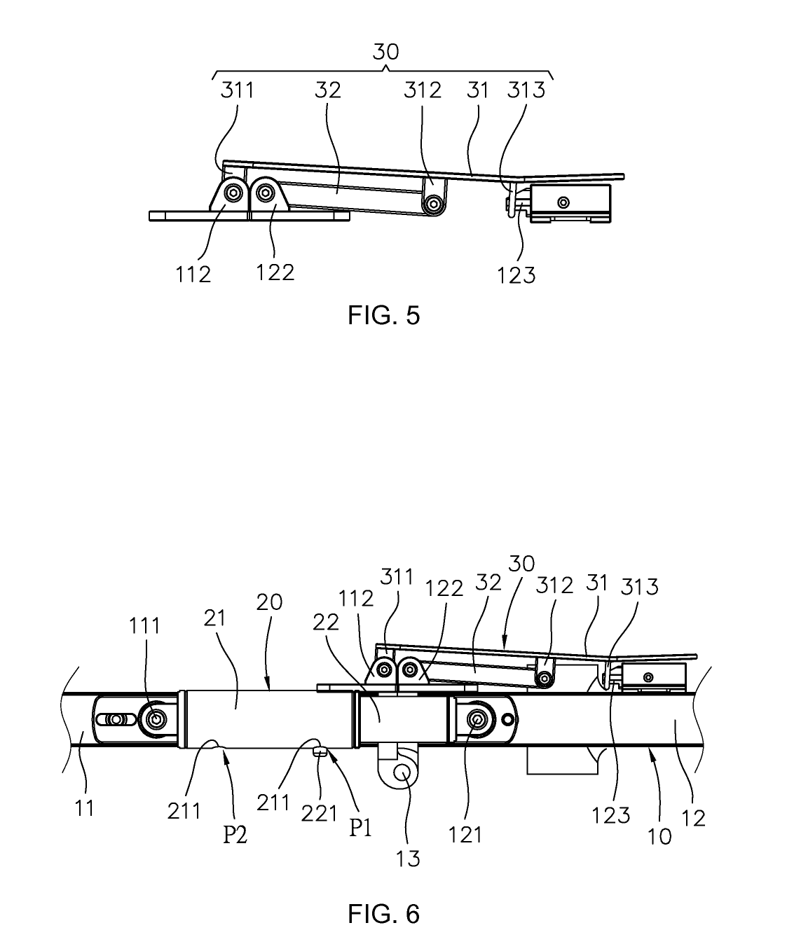

The folding switch 30 is a four-bar linkage mechanism used for fixing or releasing the front frame 11 and the rear frame 12 to or from each other. The folding switch 30 includes a handle 31 and a linkage 32. The handle 31 comprises a pivot end 311, a pivotal linkage connection portion 312, and a fastening portion 313. The pivot end 311 is pivotally connected to the front pivot seat 112. The fastening portion 313 can be fastened with or released from the fixing portion 123. The linkage 32 has two ends which are respectively and pivotally connected to the rear pivot seat 122 and the pivotal linkage connection portion 312. Referring to FIGS. 1 and 5, in the present embodiment of the present invention, the fastening portion 313 has a U shape, and the fixing portion 123 has the same design as the lock tongue of an ordinary door lock (i.e., with an inclined guide surface and capability of resilient extension/retraction). Thus, when the bicycle body 10 is unfolded, the fastening portion 313 can be rapidly fastened with the fixing portion 123 to effectuate fixture of the bicycle body 10.

Referring to FIG. 6, when the bicycle body 10 is unfolded, the telescopic rod 20 is in an extended state thereof while the engaging portion 221 of the inner rod member 22 is engaged with the positioning portion 211 at the first position P1 of the outer rod member 21. Meanwhile, the fastening portion 313 of the folding switch 30 is fastened with the fixing portion 123. By means of engagement of the engaging portion 221 and fastening of the fastening portion 313, the bicycle body 10 is positioned in its unfolded state and prevented from being loose.

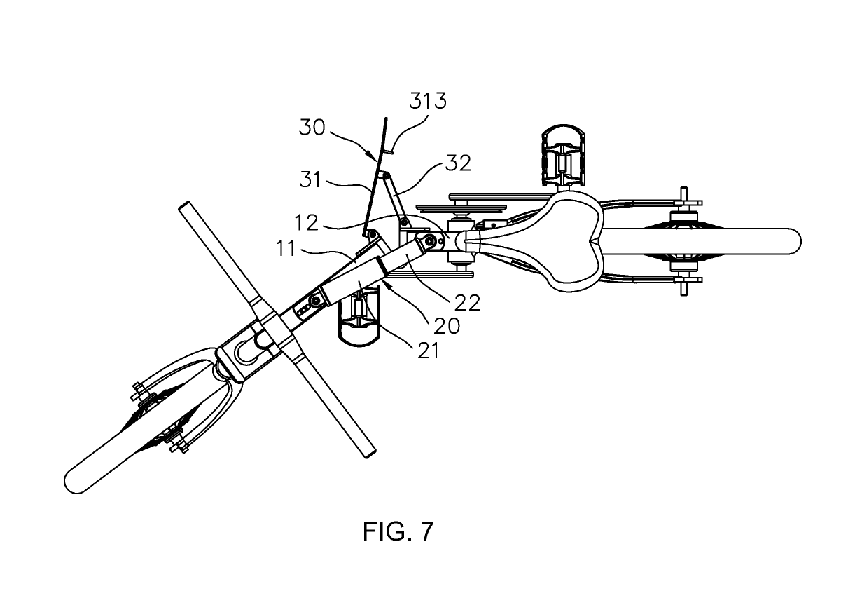

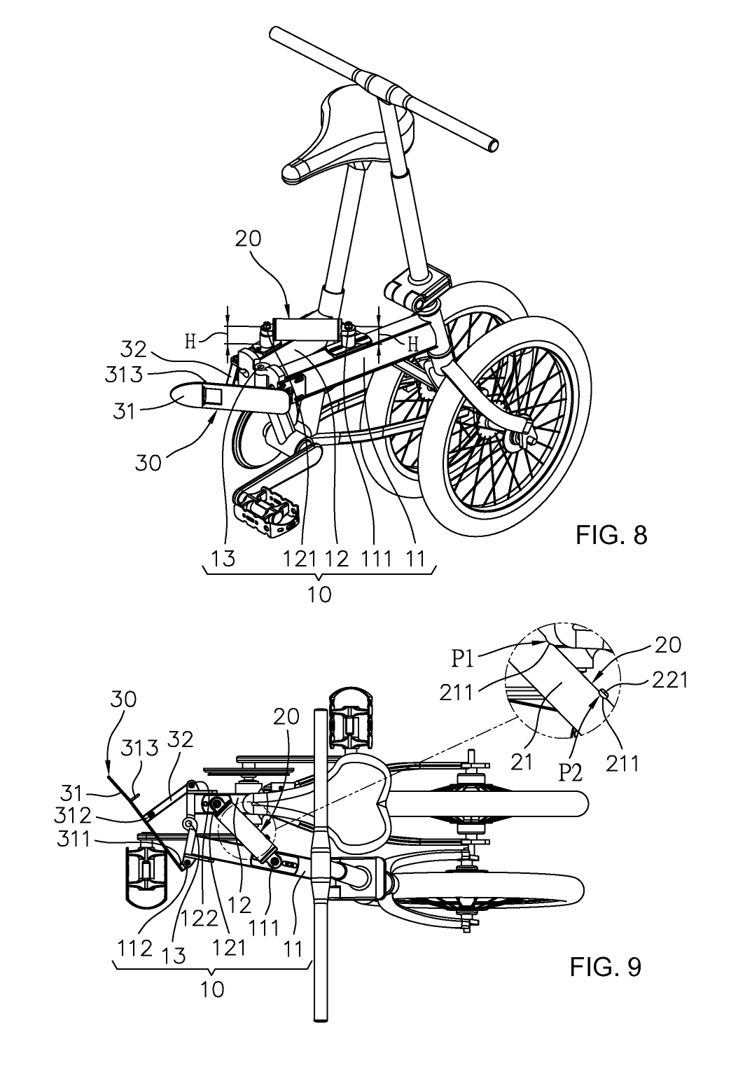

Referring to FIG. 7, the bicycle body 10 can be folded in half after the fastening portion 313 of the folding switch 30 is disengaged from the fixing portion 123. As shown in FIGS. 8 and 9, after the front frame 11 and the rear frame 12 of the bicycle body 10 are folded against each other, the telescopic rod 20 is in its retracted state (i.e., the inner rod member 22 of the telescopic rod 20 is retracted inside the outer rod member 21). Besides, the engaging portion 221 of the inner rod member 22 is engaged with the positioning portion 211 at the second position P2 of the outer rod member 21 to effectuate auxiliary positioning needed after the bicycle body 10 is folded in half and to cause the telescopic rod 20 becoming a rigid body that enhances rigidity of the bicycle body 10. Thus, even in the absence of any further fixing mechanism, the folded bicycle body 10 is prevented from swinging open due to casual placement of the folding bicycle.

It is reasonably understood that the bicycle body 10 is completely positioned by fastening of the fastening portion 313 of the handle 31 while the bicycle body 10 is in its unfolded state. Hence, the outer rod member 21 may as well be designed to include only the positioning portion 211 at the second position P2. In such case, the engaging portion 221 of the inner rod member 22 stays inside the outer rod member 21 when the bicycle body 10 is in its unfolded state, and the engaging portion 221 of the inner rod member 22 is engaged with the positioning portion 211 at the second position P2 of the outer rod member 21 when the bicycle body 10 is folded in half, so as to effectuate auxiliary positioning.

As shown in FIG. 8, after the bicycle body 10 of the present invention is folded in half, the front wheel and the rear wheel of the folding bicycle correspond completely in position to each other and overlap together. In addition, the handle 31 and the linkage 32 are driven by rotation of the front frame 11 and the rear frame 12 to move and form a triangle shape, and can function as a handgrip for users to push and move the folding bicycle with the telescopic rod 20 of the present invention around.

Referring again to FIG. 8, both of the front pivot portion 111 and the rear pivot portion 121 have a predetermined height H. Hence, after the front pivot portion 111 and the rear pivot portion 121 are pivotally connected with the telescopic rod 20, the telescopic rod 20 is spaced apart from the bicycle body 10 by a predetermined distance and can be used as a handgrip to facilitate users' carrying. It is easily understandable that, when the folding bicycle of the present invention is in its folded state, both of the telescopic rod 20 and the folding switch 30 function as handgrips that facilitate users' moving and carrying of the folding bicycle according to the present invention.

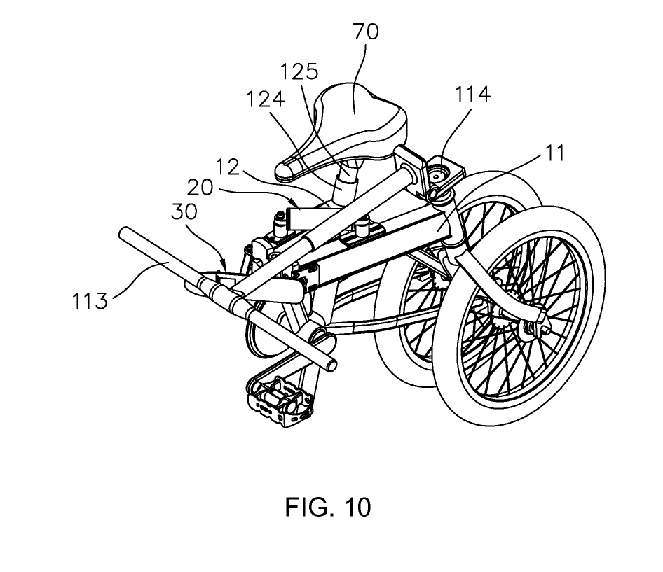

Referring to FIG. 10, the rear frame 12 is further provided with a seat tube 124 and a post 125 disposed onto the seat tube 124. The post 125 can be extended from and retracted into the seat tube 124. An outwardly extending end of the post 125 is connected to a seat 70. Besides, the front frame 11 further includes a steering frame 113 and a rotation switch 114. The rotation switch 114 controls to allow the steering frame 113 to be folded.

It can be understandable from the above that, while the bicycle body 10 is being unfolded or folded, the inner rod member 22 is driven thereby to extend from or retract into the outer rod member 21, and the engaging portion 221 is consequently engaged with the positioning portion 211 at the differently corresponding positions respectively so as to position the bicycle body 10 in its unfolded or folded state rapidly.

To sum up, according to the foregoing description, the present invention presents the following advantageous effects:

1. Increased rigidity of the bicycle body: After the folding bicycle of the present invention is folded, the telescopic rod 20 forms a rigid body and functions to increase the rigidity of the bicycle body 10.

2. Easy movability: The conventional folding bicycles, while folded, need users' laborious carrying in order to be moved. On the other hand, after the bicycle body 10 of the present invention is folded in half, the front wheel and the rear wheel of the folding bicycle completely correspond and overlap together. Users can hold either the front frame (the folding switch 30) or the telescopic rod 20 to easily move the folding bicycle. Not much labor is necessary for moving of the folding bicycle.

3. Auxiliary positioning: Plural positioning portions 211 can be disposed on the outer rod member 21 of the telescopic rod 20 according to the present invention. Hence, either one of the plural positioning portions 211 can be configured to engage with the engaging portion 221 of the inner rod member 22. Therefore, auxiliary positioning can be easily achieved by engagement of the engaging portion 221 with one positioning portion 211 located at a differently corresponding position based on the corresponding unfolding or folding state of the bicycle body 10.

4. Easy and rapid folding: The conventional folding bicycles involve in innovative folding, and hence folding steps thereof are complicated. Users need to be familiar with the folding steps in order to fold them rapidly. On the contrary, the telescopic rod 20 and the four-bar linkage folding switch 30 of the present invention facilitate simplification of the folding process of the bicycle body 10 so as to have advantage of folding the folding bicycle easily and rapidly.

5. Lower costs: The conventional folding bicycles adopt unique and innovative folding methods to promote their brand awareness, and therefore are involved in more complicated technical scopes. Hence, their selling prices are always high. In comparison, the present invention uses the structurally simple telescopic rod 20 and four-bar linkage folding switch 30 to enable rapid folding, and consequently costs thereof are much lower.

The embodiment described above for illustrating the present invention in detail is only the preferred embodiment of the present invention. All easily conceivable changes or modifications made to the disclosed embodiment should fall within the scope of the present invention, which is defined only by the appended claims.

What is claimed is:

1. A folding bicycle with a telescopic rod, comprising:
a bicycle body comprising a front frame, a rear frame, and a pivot joint, the front frame comprising a front pivot portion, the rear frame comprising a rear pivot portion, the front frame and the rear frame being connected by the pivot joint and being respectively pivotable about a rotation axis defined by the pivot joint so as to be folded in half;
a telescopic rod having two ends respectively and pivotally connected to the front pivot portion and the rear pivot portion; and
a folding switch for fixing the front frame and the rear frame to each other, and for releasing the front frame and the rear frame from each other;
wherein when the bicycle body is unfolded, the telescopic rod is in an extended state thereof, and the folding switch fixes the front frame and the rear frame to each other; and when the bicycle body is folded in half, the telescopic rod is in a retracted state thereof, and the folding switch releases the front frame and the rear frame from each other.

2. The folding bicycle of claim 1, wherein the front frame is laterally provided with a front pivot seat, the rear frame is laterally provided with a rear pivot seat and a fixing portion, and the folding switch comprises a handle and a linkage, the handle comprises a pivot end, a pivotal linkage connection portion, and a fastening portion, the pivot end is pivotally connected to the front pivot seat, the fastening portion is fastenable to and releasable from the fixing portion, the linkage comprises two ends respectively and pivotally connected to the rear pivot seat and the pivotal linkage connection portion.

3. The folding bicycle of claim 1, wherein the telescopic rod comprises an outer rod member and an inner rod member, the outer rod member comprises at least a positioning portion, the inner rod member comprises an engaging portion for engaging with the at least a positioning portion so as to effectuate auxiliary positioning.

4. The folding bicycle of claim 1, wherein both of the front pivot portion and the rear pivot portion have a predetermined height away from the bicycle body, after the telescopic rod is pivotally connected to the front pivot portion and the rear pivot portion, the telescopic rod is spaced apart from the bicycle body by a predetermined distance so as to function as a handgrip.

5. The folding bicycle of claim 1, wherein the rear frame comprises a seat tube and a post, the post is disposed on the seat tube and is extendable from and retractable into the seat tube, and the post comprises an outwardly extending end used to connect with a seat.

6. The folding bicycle of claim 1, wherein the front frame comprises a steering frame and a rotation switch for controlling and enabling the steering frame to be foldable.
